(19) United States
(12) Patent Application Publication
(10) Pub. No.: US 2004/0047633 A1
(43) Pub. Date: Mar. 11, 2004

(54) System and method for high bit-rate optical time division multiplexing (OTDM)

(76) Inventors: Takeshi Hoshida, Tokyo (JP); Seemant Choudhary, San Jose, CA (US); Olga I. Vassilieva, Plano, TX (US)

Correspondence Address: BAKER BOTTS L.L.P., 2001 ROSS AVENUE, SUITE 600, DALLAS, TX, 75201-2980, US

(21) Appl. No.: 10/236,896

(22) Filed: Sep. 6, 2002

(51) Int. Cl. H04J 14/08; H04B 10/04

(52) U.S. Cl. 398/102; 398/201

(57) ABSTRACT

A method for generating a high-bit rate optical time division multiplexed communication signal includes generating a continuous wave carrier signal. A phase of the carrier signal is modulated separately based on each of a plurality of data signals having a disparate delay with respect to each other to generate a high bit-rate signal. A first portion of the high bit-rate signal is optically delayed with respect to a second portion of the high bit-rate signal and combined to generate a high bit-rate output signal for transmission on an optical fiber.

### TECHNICAL FIELD

The present invention relates generally to optical communication networks and, more particularly, to a system and method for high bit-rate optical time division multiplexing (OTDM).

### BACKGROUND

Telecommunications systems, cable television systems and data communication networks use optical networks to rapidly convey large amounts of information between remote points. In an optical network, information is conveyed in the form of optical signals through optical fibers. Optical fibers are thin strands of glass capable of transmitting the signals over long distances with very low loss.

Optical networks can employ optical time division multiplexing (OTDM) to increase transmission capacity. In OTDM networks, a number of optical signals are carried in each fiber by imposing a disparate time delay on each signal. Network capacity is increased as a multiple of the number of time-delayed channels in each fiber.

### SUMMARY

The present invention provides a system and method for high bit-rate optical time division multiplexing (OTDM). In a particular embodiment, a continuous wave laser is used in connection with a multi-electrode serial phase modulator to multiplex a plurality of data signals into a high bit-rate OTDM phase modulated signal. An optical delay interferometer is used to generate an intensity modulated high bit-rate signal based on the phase modulated signal for transmission in an optical communications system.

In accordance with one embodiment of the present invention, a method for generating a high-bit rate optical time division multiplexed communication signal includes generating a continuous wave carrier signal. A phase of the carrier signal is modulated separately based on each of a plurality of data signals having a disparate delay with respect to each other to generate a high bit-rate signal. The high bit-rate signal is passed through an optical delay interferometer, where the high bit-rate signal is split into two portions. A first portion of the high bit-rate signal is optically delayed with respect to a second portion of the high bit-rate signal before being coupled interferometrically to generate a high bit-rate intensity modulated output signal for transmission on an optical fiber.

Technical advantages of the present invention include providing a system for high bit-rate OTDM. In one embodiment, an optical transmitter includes a continuous wave laser and n-electrode phase modulator that modulates the generated carrier signal based on a plurality of data signals to generate a high bit-rate signal. Thus, the transmitter is more compact and less expensive than conventional transmitters, which employ short-pulse optical sources. In addition, optical insertion loss is limited by the elimination of n-splitter branches of conventional systems. In a particular embodiment, the transmitter modulates the phase of a carrier signal based on each data signal. The input data signals may be non-return to zero data streams (NRZ). An optical delay interferometer converts the phase-modulated signal into a return-to-zero (RZ) signal. Thus, the transmitter is operable to receive NRZ data streams and convert the data streams into an RZ signal.

Another technical advantage of one or more embodiments of the present invention includes an OTDM transmitter that can be configured for various duty ratios. In particular, the optical delay interferometer is configurable to a variety of duty ratios depending on the needs of the optical network in which the optical delay interferometer is employed. A variable duty ratio may be achieved by redesigning the delay between the two arms of a Mach-Zehnder interferometer, or other optical delay interferometer. As a result, the transmission performance may be enhanced by optimizing a pulse duty ratio. Moreover, the OTDM optical signal may have a one hundred percent (100%) duty ratio, which corresponds to an NRZ signal, with a relatively low Q-factor penalty. Thus, a low dependence on the pulse width in the present invention may increase flexibility in the system optimization by duty cycle.

Still another technical advantage of one or more embodiments of the present invention includes providing an optical transmitter with an improved tolerance of non-linear effects. In particular, alternating optical phases of neighboring bits in the optical signal results in reduced pulse interactions.

Yet another technical advantage of one or more embodiments of the present invention is an optical transmitter that provides a high bit-rate OTDM optical signal. In a particular embodiment, two 40 gigabits per second NRZ data streams may be transmitted as an 80 gigabit per second RZ signal. Thus, an 80 gigabits per second RZ signal is generated in a transmitter that is cost effective and compact in modulator size. Thus, improved performance optical networks may be designed and implemented at a reduced cost.

Other technical advantages of the present invention will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description taken in conjunction with the accompanying drawings, wherein like numerals represent like parts, in which:

FIG. 1 is a block diagram illustrating an exemplary optical communication system in accordance with one embodiment of the present invention;

FIG. 2 is a block diagram illustrating the optical delay interferometer of FIG. 1 in accordance with one embodiment of the present invention;

FIG. 3 is a graph illustrating exemplary technical characteristics of the OTDM signals in accordance with one embodiment of the present invention;

FIG. 4 is a flow diagram illustrating a method for generating a high bit-rate optical time division multiplexing (OTDM) optical signal in accordance with one embodiment of the present invention;

FIG. 5 is a graph illustrating exemplary performance characteristics of an OTDM transmitter in accordance with one embodiment of the present invention; and

FIG. 6 is a graph illustrating exemplary performance characteristics of an OTDM transmitter in accordance with one embodiment of the present invention.

### DETAILED DESCRIPTION

FIG. 1 illustrates an optical communication system 10 in accordance with one embodiment of the present invention. In this embodiment, the optical communication system 10 is an optical time division multiplexed (OTDM) system in which a number of optical signals are carried in the transmission fiber. It will be understood that the optical communication system 10 may comprise other suitable multi-channel or bi-directional transmission systems. Optical communication system 10 may be a long-haul, metro ring, metro core, or other suitable network or combination of networks.

Referring to FIG. 1, the OTDM system 10 includes an OTDM transmitter 12 at a source end point and an OTDM receiver 14 at a destination end point coupled together by an optical link 16. OTDM transmitter 12 transmits data of a plurality of channels in an OTDM signal over the optical link 16 to the remotely located OTDM receiver 14. In one embodiment, as described in more detail below, the OTDM signal may be a non-return-to-zero (NRZ) signal with improved tolerance to non-linear effects.

The optical link 16 comprises optical fiber or other suitable medium in which optical signals may be transmitted with low loss. Interposed along the optical link 16 may be one or more optical amplifiers 30. The optical amplifiers 30 increase the strength, or boost, the OTDM signal, without the need for optical-to-electrical conversion. Signal regenerators may be provided as needed along the optical link 16.

In one embodiment, the optical amplifiers 30 comprise rare earth doped fiber amplifiers, such as erbium doped fiber amplifiers (EDFAs), erbium doped wave guide amplifiers (EDWAs), and other suitable amplifiers operable to amplify the OTDM signal at a point in the optical link 16. In other embodiments, for example, the optical amplifiers 30 may comprise a neodymium doped fiber, a thulium doped fiber, a doped wave guide, or other suitable gain medium. In another embodiment, distributed amplifiers may also be utilized to amplify the OTDM signal, for example, distributed Raman amplifiers (DRA).

The OTDM transmitter 12 includes continuous wave laser 20, multi-electrode phase modulator 22, and optical delay interferometer 24 optically coupled to each other. Continuous wave laser 20, multi-electrode phase modulator 22, and optical delay interferometer 24 may be coupled together by optical fiber, waveguides in a planar lightwave circuit, free-space optics, or otherwise suitably coupled such that an optical signal may be passed between the coupled components.

Continuous wave laser 20 is an optical light source emitter, operable to generate a carrier signal at a prescribed or selected frequency with good wavelength control. As used herein, continuous wave means a substantially constant, continuous, steady, or otherwise ongoing signal as opposed to a pulse or burst signal. Continuous wave laser 20 may be a distributed feedback laser, tunable laser, non-tunable laser or other suitable energy source operable to provide light energy. Typically, the wavelengths emitted by continuous wave laser 20 are selected to be within the 1500 nanometer (nm) range, the range at which the minimum signal attenuation occurs for silica-based optical fibers. More particularly, the wavelengths are generally selected to be in the range from 1310 to 1650 nanometers but may be suitably varied.

Multi-electrode phase modulator 22 may be a one component phase modulator with n-electrodes, each electrode operable to receive a data signal and modulate the phase of the carrier signal based on the data signal, or a series of individual phase modulators each configured to modulate the phase of the carrier signal based on pre-coded data signals. The data signals are progressively delayed by delays 35 based on their cardinal order within a bit. The delays 35 may be electrical and operate through the imposition of different electrical transmission lengths. Thus, the first bit is delayed by 0, the second bit is delayed by τ, the third bit is delayed by 2τ, and the nth bit is delayed by (n−1)τ, where τ is the selected delay time. The data signals may be otherwise suitably delayed. The multi-electrode phase modulator 22 may be driven at a voltage to effect a phase shift of pi (π) radians.

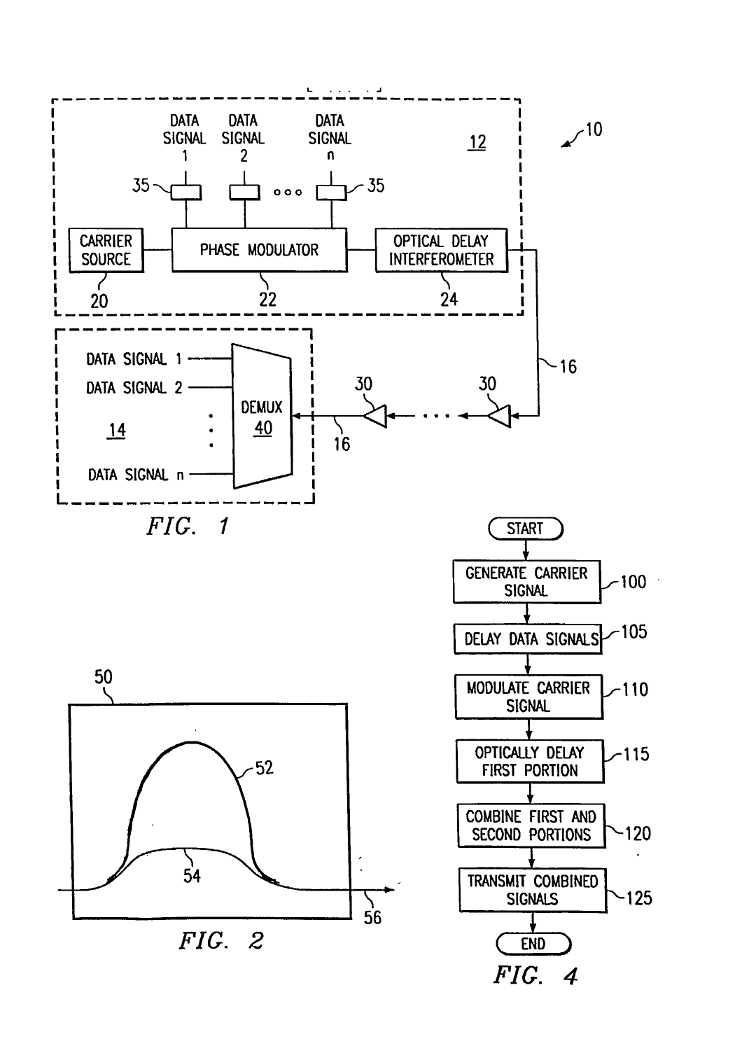

Optical delay interferometer 24 may be a Mach-Zehnder interferometer, a birefringent fiber followed by a polarizer, or other suitable optical component operable to delay a first portion of an optical signal with respect to a second portion of the optical signal and to then combine the portions to generate specified interference and a resultant output signal. The Mach-Zehnder embodiment is described below in connection with FIG. 2. In the birefringent fiber embodiment, a birefringent fiber includes two transmission axes, a “fast” axis and a “slow” axis. The difference in transmission speeds between the fast and slow axes operate to introduce a delay with a similar effect as that of an MZI. A polarizer may be employed to align the polarization of the light output from the birefringent fiber.

In operation the continuous wave laser 20 generates a carrier signal. The output of continuous wave laser 20 is fed to the multi-electrode phase modulator 22. Each electrode of multi-electrode phase modulator 22 is driven by a different one of the low speed differentially encoded NRZ data streams D₁, D₂, . . . Dₙ. Each data stream is electrically delayed by a different factor of τ. For example, as described above, the first data stream is delayed by 0τ, the second data stream is delayed by τ, the third data stream is delayed by 2τ, and the nth data stream is delayed by (n−1)τ. The delay τ may be equal to the bit duration of the multiplexed signal divided by the number of channels. In this embodiment, τ is the bit duration of the multiplexed data. The delay factor τ may be otherwise suitably selected.

The resulting output signal is a differentially encoded phase modulated optical signal at a high bit-rate. As used herein, high bit-rate means a bit-rate greater than the bit rate of the original low speed NRZ data streams D₁, D₂, . . . Dₙ. The high bit rate signals may be 40 Gb/s, 80 Gb/s or other suitable rate. The output of multi-electrode phase modulator 22, a differential phase shift keying (DPSK) signal, is transmitted to the optical delay interferometer 24. This signal is then converted to an RZ signal by passing the signal through the optical delay interferometer 24, which is adjusted to achieve either completely destructive interference or completely constructive interference in the case of the absence of the optical phase change.

In one embodiment, optical delay interferometer 24 is an asymmetric Mach-Zehnder interferometer (MZI) with a delay between the two arms of the MZI that defines the RZ duty ratio. Thus, the optical delay interferometer converts a DPSK signal to an intensity modulated RZ (IM-RZ) signal. Because the pulse width is based on the length of the longer arm of the MZI, a pulse width and duty ratio may be configured as desired, by selecting the length of the delay arm of the MZI.

The OTDM signal is realized by taking advantage of the exclusive-OR (XOR) nature of binary phased shift keying with a phase swing of pi (π). As described in more detail below, the phases of the two or more optical signals are modulated by the two or more pre-encoded NRZ data streams. The signals are then XOR-ed such that if the number of logical 1's is an odd number, then the resulting phase is π, otherwise it is zero. The resulting output signal is a differentially encoded phase modulated signal at a high bit-rate. At the output of the MZI, two or more fields with delayed phases are superimposed such that there is either a destructive interference or a constructive interference in the absence of the optical phase change, thus the phase modulated signal is converted into a RZ signal.

OTDM receiver 14 includes an OTDM demultiplexer 40. Demultiplexer 40 is operable to receive an OTDM signal and retrieve the component data signals from the multiplexed OTDM signal. Demultiplexer 40 may comprise one or a plurality of Mach-Zehnder interferometer (MZI) switches, or other suitable optical component operable to receive an OTDM signal and demultiplex the OTDM signal into discrete data signals.

FIG. 2 illustrates one embodiment of the optical delay interferometer 24 of FIG. 1. Referring to FIG. 2, optical delay interferometer 50 is an asymmetric Mach-Zehnder or other suitable interferometer operable to convert a non-intensity modulated optical information signal into an intensity modulated optical information signal for detection of data at the destination. Optical delay interferometer 50, in the Mach-Zehnder embodiment, splits the received optical signal into two interferometer paths 52 and 54 of different lengths and then combines the two paths 52 and 54 interferometrically to generate signal 56. The Mach-Zehnder interferometer may include a power splitter to split the received optical signal and a power combiner to combine the first and second potions of the signal. Path signals 52 and 54 are combined such that there is either a destructive or constructive interference between path signals 52 and 54 in the absence of an optical phase change in the underlying path signals 56 and 58.

In particular, the optical path difference (L) is equal to the bit rate (B) multiplied by the speed of light (c), multiplied by the duty cycle (D) and divided by the optical index of the paths (n). Expressed mathematically: L=BcD/n. In a particular embodiment, the two path lengths are sized based on the symbol- or bit-rate and a duty cycle of the output RZ pulse.

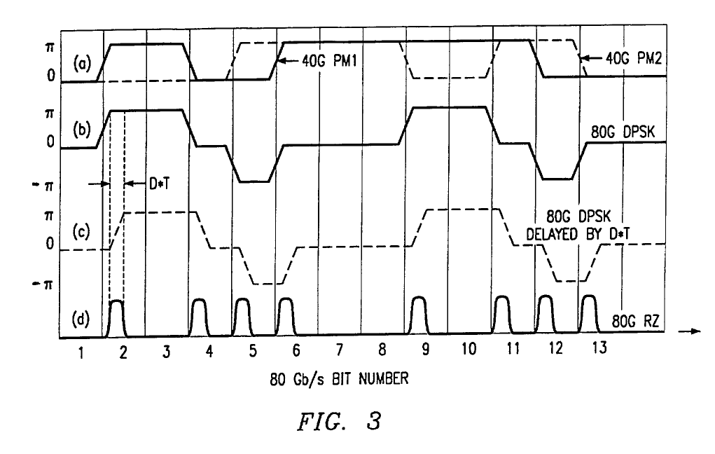

FIG. 3 illustrates an exemplary generation of the OTDM signal in accordance with one embodiment of the present invention. In the illustrated graph, section (a), two 40 gigabit per second phase modulated signals are illustrated. As shown, the phase of the optical signal PM2 is delayed with respect to the optical signal PM1. In section (b), the signals PM1 and (delayed) PM2 are combined using the exclusive-OR (XOR) method as described above, and the combined resultant 80 gigabit per second DPSK signal is illustrated. In section (c), the corresponding delayed 80 gigabit per second DPSK signal is illustrated, as delayed by the optical delay interferometer factor. As described in more detail above, the delay imposed by the optical delay interferometer determines the pulse width (and therefore duty cycle) of the OTDM signal. Because the optical delay interferometer is modifiable, various duty cycles may be readily achieved by adjusting the delay imposed by the optical delay interferometer. The resultant 80 gigabit per second RZ signal at the output of the optical delay interferometer is illustrated by section (d).

FIG. 4 illustrates a method for generating a high bit rate OTDM signal in accordance with one embodiment of the present invention. The method begins at step 100 wherein a continuous wave carrier signal is generated. The signal is generated by the continuous wave laser 20 of OTDM transmitter 12 of system 10 of FIG. 1. Next at step 105, pre-coded data signals are delayed based on a delay τ. In one embodiment, this step may be performed by electrical delays 35 in multi-electrode phase modulator 22 of OTDM transmitter 12 of FIG. 1. If, for example, the data signal is the first, or first-in-time signal, the delay is zero. The remaining signals are delayed by the appropriate delay factor given the data signal's place in the overall bit transmission. Next at step 110, the carrier signal is modulated sequentially based on the pre-coded data signals. In one embodiment, this step is performed by multi-electrode phase modulator 22 of FIG. 1.

Next at step 115, a first portion of the high bit-rate signal is optically delayed relative to a second portion of the high bit-rate signal to convert the high bit-rate signal into an RZ signal. Next at step 120, the first portion and second portion of the high bit-rate signal are combined. In one embodiment, steps 115 and 120 are performed by optical delay interferometer 24 of FIG. 1. Next, at step 125, the combined signal is transmitted and the process ends.

Although the method of FIG. 4 has been shown with specific steps in a specific order, it will be understood that the steps may be performed in a different order as appropriate, and other steps may be added or omitted as appropriate in keeping with the spirit of the present invention.

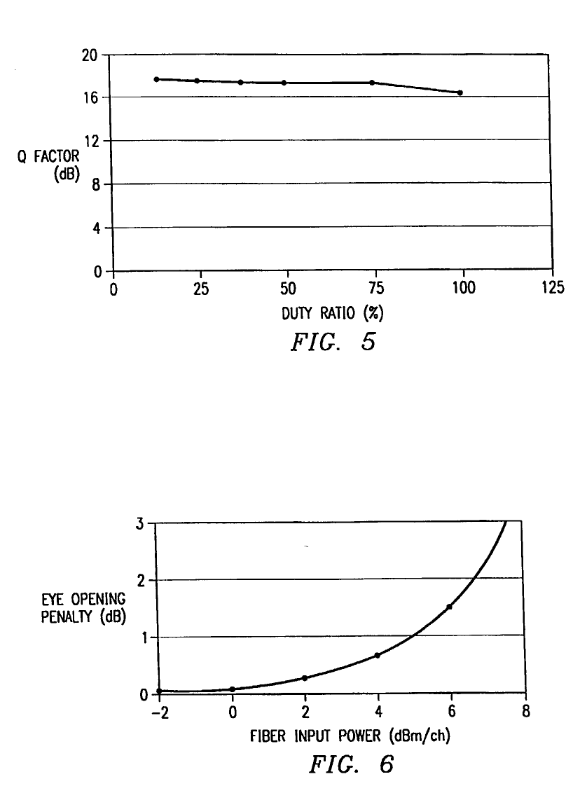

FIG. 5 illustrates exemplary performance characteristics of the transmitter of FIG. 1, in accordance with one embodiment of the present invention. In particular, the transmitter includes two phase modulators in series driven by pre-coded forty (40) Gb/s NRZ data streams and an asymmetric Mach-Zehnder interferometer (MZI) with a delay between two arms that defines the RZ duty ratio. FIG. 5 shows the Q factor of the central channel without fiber transmission at an optical signal-to-noise ratio of twenty-five (25) dB. The results are shown for five 80 Gb/s wavelength division multiplexing (WDM) channels with 200 Ghz spacing, assuming a second order Gaussian filter for multiplexing and de-multiplexing with an optimum bandwidth of 160 GHz. As shown, the transmitter exhibits very low dependence on the duty ratio. Moreover, the transmitter allows generation of a signal at 100% duty ratio, which corresponds to an NRZ signal, with only a 0.6 dB penalty in the Q factor. Thus, the transmitter's low dependence on the pulse width adds flexibility in system optimization by duty cycle. Moreover, the transmitter exhibits at least three (3) decibel (dB) less optical insertion loss in total compared to conventional OTDM systems and methods. The Q factor is a measure of signal quality that is related to the theoretical bit-error rate achieved by an ideal receiver as follows:

$$Q = 20 log ( \sqrt{2} {erfc}^{- 1} ( 2 BER ) ) , where erfc ( s ) = \frac{2}{\sqrt{π}} {\int }_{s}^{∞} exp ( - {x}^{2} ) ⅆ x .$$

FIG. 6 illustrates exemplary performance characteristics of the transmitter of FIG. 1, in accordance with one embodiment of the present invention. In particular, the transmitter includes two phase modulators in series driven by pre-coded forty (40) Gb/s NRZ data streams and an asymmetric Mach-Zehnder interferometer (MZI) with a delay between two arms that defines the RZ duty ratio. FIG. 6 shows the simulated average eye opening penalties at a 25% duty ratio in a 5×80 Gb/s WDM transmission over 6×100 km standard single mode fiber (SMF). Dispersion of SMF was compensated at the end of each span. Chromatic dispersion was assumed at 17.0 and −80.0 ps/nm/km, dispersion slope at 0.06 and −0.2 ps/nm²/km, effective area at 80 and 14 μm², and a nonlinear index at 2.9 and 4.3 m²/W for SMF and dispersion compensating fiber, respectively. The optical filter bandwidth was at the optimum value of 160 Ghz. The eye-opening penalty is defined as 20 log (lₜ/l_{b}) where lₜ and l_{b} are eye opening percentages with and without transmission. As shown, the transmitter exhibits a high tolerance to non-linear effects such as self-phase modulation and cross-phase modulation (SPM/XPM). Where a 1.5 dB eye opening penalty is allowed in the system design, the illustrated embodiment exhibits a 1.6 dB improvement in the optical power limit.

Although the present invention has been described with several embodiments, various changes and modifications may be suggested to one skilled in the art. It is intended that the present invention encompass such changes and modifications as fall within the scope of the appended claims and their equivalents.

What is claimed is:

1. A method for generating a high-bit rate optical time division multiplexed communication signal, comprising:
generating a continuous wave carrier signal;
separately modulating a phase of the carrier signal based on each of a plurality of data signals having a disparate delay with respect to each other to generate a high bit-rate signal; and
optically delaying a first portion of the high bit-rate signal with respect to a second portion of the high bit-rate signal and combining the first and second portions to generate a high bit-rate output signal for transmission on an optical fiber.

2. The method of claim 1, wherein the data signals comprise non-return to zero (NRZ) signals.

3. The method of claim 1, wherein the carrier signal phase is modulated in steps of pi radians.

4. The method of claim 1, wherein the delay is based on a bit duration of the high bit-rate output signal.

5. The method of claim 1, wherein the high bit-rate signal comprises a differential phase shift keyed (DPSK) signal.

6. The method of claim 1, wherein the first portion of the high bit-rate signal is optically delayed in a Mach-Zehnder interferometer (MZI).

7. The method of claim 1, wherein the first portion of the high bit-rate signal is optically delayed based on a specified duty ratio.

8. The method of claim 1, wherein the high bit-rate output signal is an intensity modulated return-to-zero (IM-RZ) signal.

9. A transmitter for an optical communication system, comprising:
a continuous wave laser operable to generate a carrier signal;
a multi-electrode phase modulator, each electrode of the phase modulator operable to modulate the carrier signal from the continuous wave laser based on a disparate one of a plurality of discrete data channels to generate a high bit-rate signal, the data channels each having a disparate delay with respect to each other; and
an optical delay interferometer operable to receive the high bit-rate signal from the multi-electrode phase modulator, to delay a first portion of the high bit-rate signal relative to a second portion of the high bit-rate signal and to combine the first and second portions to generate an output high bit-rate signal.

10. The transmitter of claim 9, wherein the multi-electrode phase modulator comprises a plurality of serially coupled phase modulators.

11. The transmitter of claim 9, wherein the high bit-rate signal comprises a differential phase shift keying (DPSK) modulated signal.

12. The transmitter of claim 9, wherein the optical delay interferometer comprises a Mach-Zehnder interferometer (MZI).

13. The transmitter of claim 9, wherein the respective delays of the data signal are based on a bit duration of the high bit-rate output signal.

14. The transmitter of claim 9, wherein the first portion of the high bit-rate signal is optically delayed based on a specified duty ratio.

15. The transmitter of claim 9, wherein the multi-electrode phase modulator is driven at a voltage to effect a phase shift of pi radians.

16. A system for generating a high-bit rate optical time division multiplexed communication signal, comprising:
means for generating a continuous wave carrier signal;
means for separately modulating a phase of the carrier signal based on each of a plurality of data signals having a disparate delay with respect to each other to generate a high bit-rate signal; and
means for optically delaying a first portion of the high bit-rate signal with respect to a second portion of the high bit-rate signal and for combining the first and second portions to generate a high bit-rate output signal for transmission on an optical fiber.

17. The system of claim 16, wherein the data signals comprise non-return to zero (NRZ) signals.

18. The system of claim 16, wherein the carrier signal phase is modulated in steps of pi radians.

19. The system of claim 16, wherein the delay is based on a bit duration of the high bit-rate output signal divided by the number of data signals.

20. The system of claim 16, wherein the high bit-rate signal comprises a differential phase shift keyed (DPSK) signal.

21. The system of claim 16, wherein the first portion of the high bit-rate signal is optically delayed in a Mach-Zehnder interferometer (MZI).

22. The system of claim 16, wherein the first portion of the high bit-rate signal is optically delayed based on a specified duty ratio.

23. The system of claim 16, wherein the high bit-rate output signal is an intensity modulated return-to-zero (IM-RZ) signal.

24. A transmitter for an optical time division multiplexed communication system, comprising:
a continuous wave laser operable to generate a carrier signal;
a phase modulator including at least a first phase modulator and a second phase modulator coupled in series;
the first phase modulator operable to modulate the carrier signal from the continuous wave laser based on a first pre-coded non-return-to-zero data stream to generate a first modulated signal;
the second phase modulator operable to modulate the first modulated signal from the first phase modulator based on a second pre-coded non-return-to-zero data stream to generate a differential phase shift keyed high bit-rate signal, the second precoded non-return-to-zero data stream having an electrical delay relative to the first pre-coded non-return-to-zero data stream; and
an optical delay interferometer operable to receive the differential phase shift keyed high bit-rate signal from the phase modulator, to delay a first portion of the differential phase shift keyed high bit-rate signal relative to a second portion of the differential phase shift keyed high bit-rate signal, and to combine the first and second portions to generate an intensity modulated return-to-zero optical time division multiplexed high bit-rate signal.
